(19) United States
(12) Patent Application Publication
(10) Pub. No.: US 2013/0112780 A1
(43) Pub. Date: May 9, 2013

(54) MULTI-SAC INJECTOR

(71) Applicants: Hyunsung Jung, Anyang-si (KR); Dae Choi, Hwaseong-si (KR); Hyeungwoo Lee, Suwon-si (KR)

(72) Inventors: Hyunsung Jung, Anyang-si (KR); Dae Choi, Hwaseong-si (KR); Hyeungwoo Lee, Suwon-si (KR)

(73) Assignee: Hyundai Motor Company, Seoul (KR)

(21) Appl. No.: 13/584,614

(22) Filed: Aug. 13, 2012

(30) Foreign Application Priority Data
Nov. 8, 2011 (KR) 10-2011-0115864

(51) Int. Cl. F02M 63/00

(52) U.S. Cl. 239/533.2

(57) ABSTRACT

A multi-sac injection includes a main sac located at the center of a nozzle such that an injected fuel formed a low load cone angle to inject a fuel for pre-mixed combustion, and sub-sacs located at sides of the nozzle such that the injected fuel forms a middle/high load cone angle large relative to a low load cone angle to inject a fuel for diffusive combustion. Accordingly, smoke and NOx are significantly reduced in a low load region while maintaining features of a middle/high load region with a single injector.

### CROSS-REFERENCE TO RELATED APPLICATIONS

The present application claims priority of Korean Patent Application Number 10-2011-0115864 filed Nov. 8, 2011, the entire contents of which application is incorporated herein for all purposes by this reference.

### BACKGROUND OF INVENTION

1. Field of Invention

The present invention relates to an injector, and more particularly, to a multi-sac injector which performs a fuel injection operation for pre-mixed combustion in a low load region and performs a burning injection operation for diffusive combustion in a middle/high load region, making it possible to maximize engine burning efficiency in an entire load region.

2. Description of Related Art

In general, an injector has a hole formed in a circumferential direction thereof at a tip end of a nozzle such that a fuel can be discharged through the hole through movement of a needle.

Such injectors are classified into VCO (valve covering orifice) nozzle type injectors and sac nozzle type injectors according to types of fuel injection.

A VCO nozzle type injector is constructed such that a tip end of a needle completely blocks a nozzle, whereas a sac nozzle type injector is constructed such that a needle does not completely block a nozzle.

However, a plurality of holes for fuel injection are formed only at fixed positions on a circumference of such an injector. Accordingly, a cone angle indicating an angle at which the hole of the injector is formed is fixed to one angle, and a constant injection angle is always formed irrespective of a load of an engine load region.

When a cone angle formed by a hole of an injector is constant so that a fuel is injected at a constant fuel injection angle, an engine performs only conventional combustion irrespective of a load of the engine.

Conventional combustion refers to diffusive combustion, and this method is generally advantageous in a middle/high load region of an engine, but increases a possibility of producing a large amount of contaminants due to an increase in smoke and NOx particularly in a low load region.

An example of a method of reducing smoke and NOx includes HCCI (homogeneous charge compression ignition).

When being applied to a low load region of an engine, the HCCI can significantly reduce smoke and NOx. In this case, it is necessary to satisfy a precondition that an angle of a fuel injected from a hole of an injector should be made small as compared with general diffusive combustion.

The small injection angle of fuel means that a cone angle is relatively small, and means that a hole formed in an injector has a relatively small angle.

However, as mentioned above, the injector having a hole with a fixed cone angle has a basic limit in that only diffusive combustion is realized in both a low load region and a middle/high load region due to the constant injection angle.

The information disclosed in this Background section is only for enhancement of understanding of the general background of the invention and should not be taken as an acknowledgement or any form of suggestion that this information forms the prior art already known to a person skilled in the art.

### SUMMARY OF INVENTION

Various aspects of the present invention provide for a multi-sac injector which injects a fuel at a relatively small cone angle in a low load region based on an injector cone angle for diffusive combustion in a middle/high load region, whereby pre-mixed combustion can be achieved in a low load region and diffusive combustion can be achieved in a middle/high load region with a single injector, making it possible to maximize an engine combustion efficiency in an entire load region and particularly significantly decrease contaminants due to smoke and NOx in a low load region.

Various aspects of the present invention provide for a multi-sac injector, including: a nozzle including a nozzle chamber classified into a central space coinciding with an axial central line and connected to a tip end portion of the nozzle along the axial central line to form a space through which a fuel flows and a side space being concentric to the central space to form a flow space for another fuel and being separated to be short relative to the central space; needles located in the central flow space and the separated side space to be moved, respectively; a main sac formed in the nozzle so that a fuel is injected due to movement of the needle located in the central flow space to be communicated with the central flow space such that the injected fuel forms a low load cone angle; and a sub sac formed in the nozzle so that a fuel is injected due to movement of the needle located in the separated side space to be communicated with the separated side space such that the injected fuel forms a middle/high load angle to be large relative to the low load cone angle.

The needle may have a construction where the main sac and the sub sac coincide with each other

The main sac may be formed at a nose portion of the nozzle which is a protruding tip end portion of the nozzle to be communicated with the central space, and the sub sac may be formed in a convergence body formed between the nozzle nose and the nozzle body to be communicated with the separated side space.

The main sac may be varied according to the shapes of an actuator and the needle) of the injector, whereas the sub sac may have a cylindrical shape having a volume to be small relative to the main sac.

The sub sac may be classified into a left sub sac and a right sub sac symmetrical to each other with respect to the axial central line of the nozzle nose where the main sac is formed, and the left sub sac and the right sub sac may have the same diameter and shape.

The left sub sac and the right sub sac may be arranged at a circumference of a cylindrical shape about the axial central line of the nozzle.

An injection angle of the left sub sac and an injection angle of the right sub sac may have the same angle or different angles.

The central space and the separated side space of the nozzle may be separated in an interior of the nozzle body so that different fuels flow while not being mixed.

According to various aspects of the present invention, as pre-mixed combustion is achieved in a low load region and diffusive combustion is achieved in a middle/high region, an engine combustion efficiency can be maximized in an entire load region.

Further, since the present invention realizes pre-mixed combustion such as homogeneous charge compression ignition (HCCI) in a low load region, contaminants due to smoke and NOx can be significantly reduced.

In addition, since a fuel is injected at a relatively small cone angle in a low load region based on an injector cone angle for diffusive combustion in a middle/high load region with a single injector, both pre-mixed combustion and diffusive combustion can be realized without an additional system construction.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIGS. 1 and 2 are sectional views showing a nozzle portion of an exemplary multi-sac nozzle type injector according to the present invention.

FIG. 3 shows injection states of an exemplary multi-sac nozzle type injector of the present invention according to operation regions thereof.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

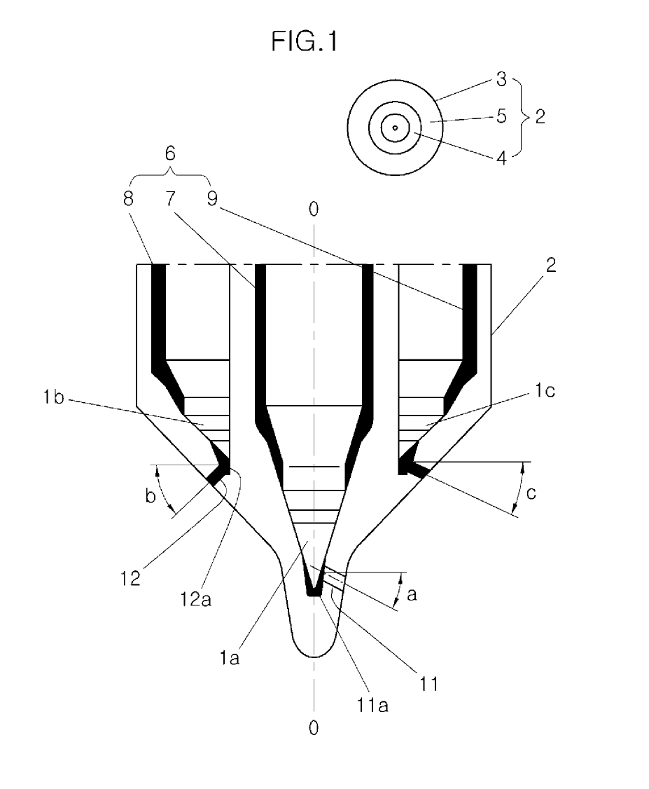

Referring to FIG. 1, an injector includes a needle 1, a nozzle 2 having a nozzle chamber 6 where at least two fuel flow spaces are separated, and a fuel injection hole for performing fuel injection in a low load region at a relatively small cone angle based on a cone angle at which fuel injection is performed in a middle/high load region.

The fuel injection hole includes a main sac 11 for performing fuel injection suitable for pre-mixed combustion in a low load region such that a fuel is injected through a central space having an axial center line 0-0 of nozzle 2, and sub sacs 12 and 13 for performing fuel injection suitable for diffusive combustion in a middle/high load region such that the fuel is injected to the left and right sides of the central space.

Sub sacs 12 and 13 include a left sub sac 12 formed on the left side of main sac 11 and a right sub sac 13 formed on the right side of main sac 11.

Although it is illustrated in various embodiments that sub sacs 12 and 13 include left sub sac 12 and right sub sac 13, left sub sac 12 and right sub sac 13 applied to an actual injector are arranged along a circumference of a cylindrical shape formed about center line 0-0 of nozzle 2.

In general, a cone angle at which fuel injection in a middle/high load region is performed is referred to a middle/high load cone angle, whereas a cone angle small relative to the middle/high load cone angle for fuel injection in a low load region is referred to as a low load cone angle.

A detailed construction of the injector according to various embodiments is as follows.

Needle 1 includes a main nose 1a located at the center of nozzle 2 to coincide with axial center line 0-0 of nozzle 2, and a left sub nose 1b and a right sub nose 1c formed on the left and right sides of main nose 1a to be symmetrical to each other with respect to axial center line 0-0.

The left and right directions of left sub nose 1b and right sub nose 1c are determined with reference to FIG. 1.

To this end, nozzle chamber 6 formed in nozzle 2 is classified into a central space connected to a tip end portion of nozzle 2 coinciding with axial center line 0-0 to form a space through which a fuel flows, and a side space being concentric to the central space to form a flow space for another fuel and being separated to be short relative to the central space. Nozzle chamber 6 will be described in detail below.

Once needle 1 is assembled in nozzle 2, main nose 1a of needle 1 is located at a tip end portion of nozzle 2 to be located in main sac 11 having a low load cone angle at which a pre-mixed combustion fuel in a low load region is injected, whereas left and right sub noses 1b and 1c of needle 1 is located at a position high relative to main sac 11 to be located in left and right sub sacs 12 and 13 having a middle/high load cone angle at which a diffusive combustion fuel in a middle/high load region is injected.

Main sac 11 and left and right sub sacs 12 and 13 will be described in detail below.

As mentioned above, left sub sac 12 and right sub sac 13 are arranged at a circumference of a cylindrical shape about axial central line 0-0 of nozzle 2.

Meanwhile, nozzle 2 includes a nozzle body 3 accommodating needle 1, a nozzle tip end where main sac 11 and left and right sub sacs 12 and 13 having different fuel injection angles are formed in nozzle body 3, and a nozzle chamber 6 communicated with main sac 11 and left and right sub sacs 12 and 13 and forming a fuel flow passage with needle 1.

Nozzle 2 is a main element of the injector and realizes an operation of the injector with a plurality of parts which have not been described. Such parts are the same as those for a general injector.

The nozzle tip end includes a nozzle nose 4 includes a nozzle nose 4 where main sac 11 protruding to form a tip end of the nozzle and having a predetermined fuel injection angle is formed while coinciding with axial center line 0-0 of the nozzle, and a convergence body 5 concentrically expanding from nozzle nose 4 to be symmetrical with respect to axial center axis 0-0 of nozzle nose 4 and having left and right sub sacs 12 and 13 forming another predetermined fuel injection angle.

Nozzle chamber 6 includes a main chamber 7 corresponding to the center thereof by using nozzle body 3 of nozzle 2 accommodating needle 1, and a left sub chamber 8 and a right sub chamber 9 being symmetrical to each other with respect to main chamber 7.

Main chamber 7 is communicated with main sac 11 formed in nozzle nose 4 for fuel injection. Left sub chamber 8 is communicated with left sub sac 12 formed in convergence body 5 for fuel injection. Right sub chamber 9 is communicated with right sub sac 13 formed in convergence body 5 at a different position for fuel injection.

Left sub sac 12 and right sub sac 13 applied to the injector are arranged at a circumference of the cylindrical shape about axial central line 0-0 of nozzle 2.

As mentioned above, nozzle chamber 6 is classified into main chamber 7, left sub chamber 8, and right sub chamber 9 which are communicated with main sac 11, left sub sac 12, and right sub sac 13, respectively, such that the fuel supplied into main chamber 7 is injected in a low load region, whereas the fuel supplied into left and right sub chambers 8 and 9 is injected in a middle/high load region.

Thus, in the injector according to various embodiments, the fuel lines may be classified into a low load region and a middle/high load region.

To this end, although the injector is connected to a fuel line connected to main chamber 7 and another fuel line connected to left sub chamber 8 and right sub chamber 9 using the classified fuel lines, the fuel lines may extend in a single line and then be classified within an interior of the injector, respectively.

In the structural feature of the multi-sac type injector according to various embodiments, an in-use range of the injector may be varied.

As an example, an injector specified in a low load region may be used due to injection of a fuel through main sac 11, or an injector specified in a middle/high load region may be used due to injection of a fuel through left and right sub sacs 12 and 13.

In particular, a fuel line connected to main sac 11 of the injector and a fuel line connected to left and right sub sacs 12 and 13 may be configured differently.

As an example, if a gasoline fuel is supplied to the fuel line connected to main sac 11 and a diesel fuel is supplied to the fuel line connected to left and right sub sacs 12 and 13, a dual fuel vehicle using both the gasoline fuel and the diesel fuel can use only one injector, thereby achieving various advantages.

Such a dual fuel vehicle can also be applied to a gasoline-LPG vehicle or a diesel-LPG vehicle in the same fashion.

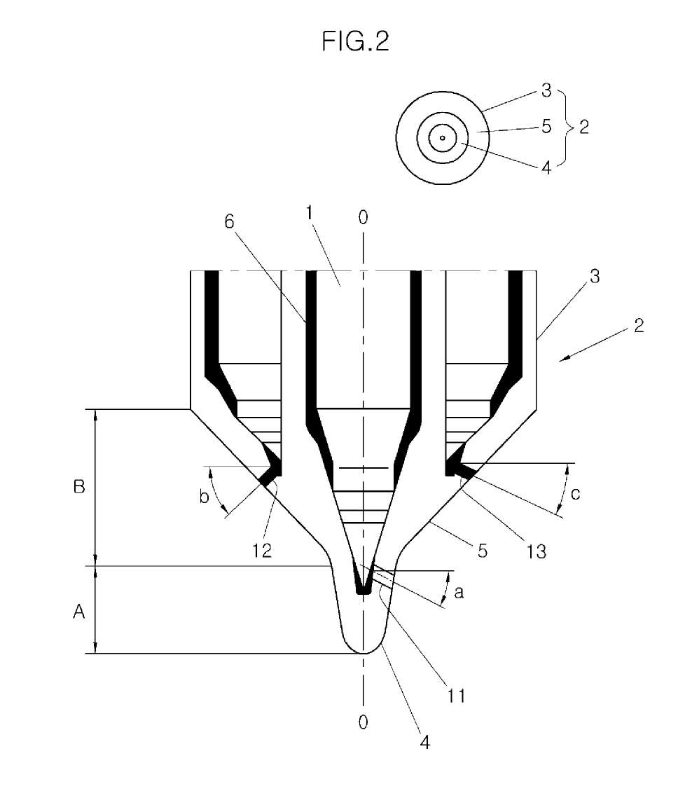

Meanwhile, referring to FIG. 2, a correlation between the nozzle tip end, and main sac 11 and left and right sub sacs 12 and 13 according to various embodiments can be identified.

That is, an overall height of the nozzle tip end is determined by a height A of nozzle nose 4 coinciding with axial central line 0-0 and forming a tip end portion protruding sharp, and a height B of convergence body 5 expanding upward from a position where height A of nozzle nose 4 ends to coincide with an outer surface of nozzle body 3.

Generally, if height A of nozzle nose 4 is determined, height B of convergence body 5 is determined, considering a diameter of nozzle nose 4 and an outer diameter of nozzle body 3.

This is because a cone angle of main sac 11 formed in nozzle nose 4 is in a low load region, whereas a cone angle of left and right sub sacs 12 and 13 formed in convergence body 5 is in a middle/high load region.

Main sac 11 is formed by a sac connecting hole 11a formed to be communicated with main chamber 7 of nozzle body 3, and sac connecting hole 11a is blocked or opened through main nose 1a located in main chamber 7.

Then, a shape of main sac 11 is selected to be of a general nozzle type according to needle 2, and a general nozzle type means that it is determined according to the form of an actuator and a needle of an injector.

As mentioned above, the cone angle formed by main sac 11 is referred to as a low load cone angle.

Left and right sub sacs 12 and 13 are formed by sac connecting holes 12a and 13a formed to be communicated with left and right sub chambers 8 and 9, respectively, and sac connecting holes 12a and 13a are blocked or opened through left and right sub noses 1b and 1c located in left and right sub chambers 8 and 9, respectively.

Then, fuel drop amounts of left and right sub sacs 12 and 13 should be regulated when the injector is cut off, and accordingly, left and right sub sacs 12 and 13 have cylindrical shapes having relatively small volumes.

As mentioned above, the cone angles formed by left and right sub sacs 12 and 13 are referred to as middle/high load cone angles.

In various embodiments, an injection angle a of main sac 11 is set to be an angle for a cone angle required in a low load region, and an injection angle b of left sub sac 12 and an injection angle c of right sub sac 13 is set to be an angle for a cone angle required in a middle/high load region.

Injection angle b of left sub sac 12 and injection angle c of right sub sac 13 are the same.

However, injection angle b of left sub sac 12 and injection angle c of right sub sac 13 may be different if necessary.

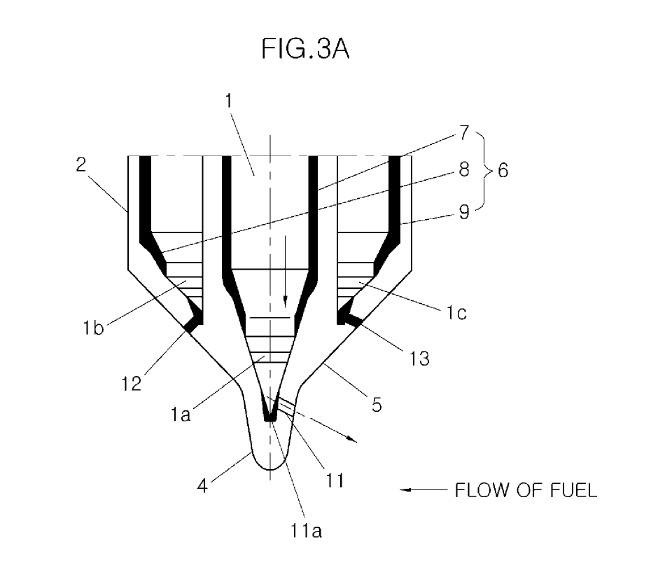

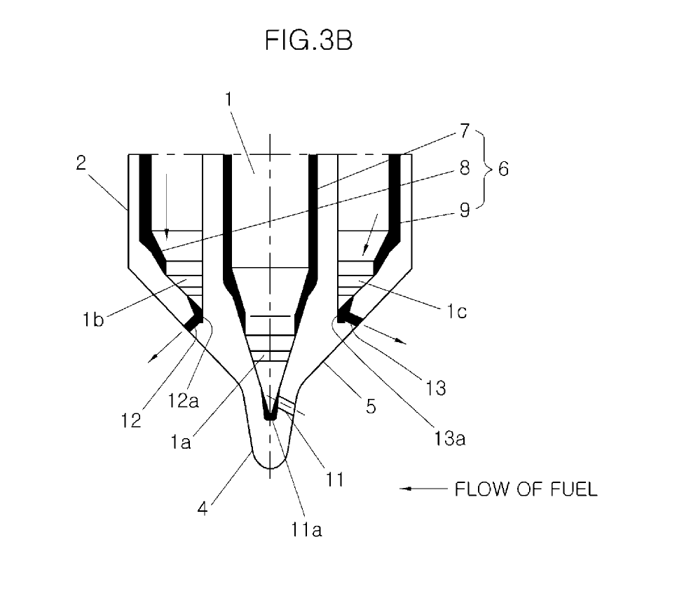

Meanwhile, FIG. 3A shows a state where the injector is controlled according to pre-mixed combustion realized in the combustion chamber in a low load region.

As shown, in the injector, main nose 1a opens sac connecting hole 11a due to movement of needle 1, and accordingly, the supplied fuel is injected through main sac 11.

Then, since the movement of needle 1 maintains a blocking state of sac connecting holes 12a and 13a due to left sub nose 1b and right sub nose 1c, injection of a fuel through left sub sac 12 and right sub sac 13 is not carried out.

Accordingly, as the injector injects a fuel only through main sac 11 having a cone angle relatively smaller than the cone angles of left sub sac 12 and right sub sac 13, injection of a fuel suitable for pre-mixed combustion realized in the combustion chamber can be carried out.

Therefore, pre-mixed combustion can be carried out in a low load region, and contaminants due to smoke and NOx can be significantly reduced through the pre-mixed combustion.

Meanwhile, FIG. 3B shows a state where the injector is controlled according to diffusive combustion realized in the combustion chamber in a middle/high load region.

As shown in FIG. 3B, in the injector, sac connecting holes 12a and 13a is opened by left sub nose 1b and right sub nose 1c due to movement of needle 1, and accordingly, the supplied fuel is injected through left sub sac 12 and right sub sac 13.

Then, as the movement of needle 1 maintains a blocking state of sac connecting hole 11a of main nose 1a, injection of a fuel through main sac 11 is not carried out.

Accordingly, as the injector injects a fuel only through left sub sac 12 and right sub sac 13 having cone angles relatively larger than the cone angle of main sac 11, injection of a fuel suitable for diffusive combustion realized in the combustion chamber can be carried out.

Thus, diffusive combustion is carried out in a middle/high load region, and a middle/high speed output can be maintained required in a middle/high load region through the diffusive combustion, maintaining the same level without increasing smoke or NOx.

In particular, as fuel injection is also converted from main sac 11 to left sub sac 12 and right sub sac 13 when an operation region is converted from a low load region t a middle/high load region, there occurs no middle/high speed penalty even though the combustion manner is converted from pre-mixed combustion to diffusive combustion.

The multi-sac injector according to various embodiments includes both main sac 11 located at the center of nozzle 2 so that the injected fuel can form a low load cone angle, thereby injecting the fuel for pre-mixed combustion, and sub sacs 12 and 13 located on sides of nozzle 2 so that the injected fuel can form a middle/high load cone angle relatively larger than a low load cone angle, thereby injecting the fuel for diffusive combustion.

Through this, smoke and NOx can be significantly reduced in a low load region while maintaining the feature of a middle/high load region with a single injector.

For convenience in explanation and accurate definition in the appended claims, the terms left and right, and etc. are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents. invention be defined by the Claims appended hereto and their equivalents.

1. A multi-sac injector, comprising:
a nozzle including a nozzle chamber forming a central space extending along an axial central line to a tip end of the nozzle to form a space through which fuel flows, and forming a side space being concentric to the central space to form a flow space for another fuel and being shorter relative to the central space;
a needle movably located in the central flow space and the separated side space, respectively;
a main sac formed in the nozzle so that a fuel is injected due to movement of the needle located in the central flow space to be communicated with the central flow space such that the injected fuel forms a low load cone angle; and
a sub sac formed in the nozzle so that a fuel is injected due to movement of the needle located in the separated side space to be communicated with the separated side space such that the injected fuel forms a middle/high load angle large relative to the low load cone angle.

2. The multi-sac injector as defined in claim 1, wherein the needle has a construction where the main sac and the sub sac coincide with each other.

3. The multi-sac injector as defined in claim 1, wherein the main sac is formed at a nose portion of the nozzle which is a protruding tip end of the nozzle to be communicated with the central space, and the sub sac is formed in a convergence body formed between the nozzle nose and the nozzle body to be communicated with the separated side space.

4. The multi-sac injector as defined in claim 3, wherein the main sac is varied according to the shapes of an actuator and the needle of the injector, whereas the sub sac has a cylindrical shape having a volume small relative to the main sac.

5. The multi-sac injector as defined in claim 4, wherein the sub sac is classified into a left sub sac and a right sub sac symmetrical to each other with respect to the axial central line of the nozzle nose where the main sac is formed, and the left sub sac and the right sub sac have the same diameter and shape.

6. The multi-sac injector as defined in claim 5, wherein the left sub sac and the right sub sac are arranged at a circumference of a cylindrical shape about the axial central line of the nozzle.

7. The multi-sac injector as defined in claim 5, wherein an injection angle of the left sub sac and an injection angle of the right sub sac have the same angle or different angles.

8. The multi-sac injector as defined in claim 6, wherein an injection angle of the left sub sac and an injection angle of the right sub sac have the same angle or different angles.

9. The multi-sac injector as defined in claim 1, wherein the central space and the separated side space of the nozzle are separated in an interior of the nozzle body so that different fuels flow while not being mixed.
